(19) United States
(12) Patent Application Publication
(10) Pub. No.: US 2015/0170079 A1
(43) Pub. Date: Jun. 18, 2015

(54) PROVIDING GUIDANCE FOR RECOVERY FROM DISRUPTIONS IN AIRLINE OPERATIONS

(71) Applicant: NIIT Technologies Ltd, New Delhi (IN)

(72) Inventors: Udayan BANERJEE, Bangalore (IN); Eswaran NARASIMHAN, Bangalore (IN); Mahesh SHASTRY, Bangalore (IN); Vikram Nagaraja RAO, Bangalore (IN)

(21) Appl. No.: 14/538,829

(22) Filed: Nov. 12, 2014

(30) Foreign Application Priority Data
Nov. 13, 2013 (IN) 5155/CHE/2013

(51) Int. Cl. G06Q 10/06; G06Q 10/10

(52) U.S. Cl. CPC G06Q 10/06311; G06Q 10/10

(57) ABSTRACT

An aspect of the present disclosure provides guidance for recovery from disruptions in airline operations. In one embodiment, a disruption data specifying the details of disruptions in airline operations and a corresponding set of tasks performed for recovery for each disruption is maintained. In response to receiving an input data indicating details of a new disruption, an earlier disruption that is closest to the new disruption is identified based on the input data and the disruption data. For example, a statistical distance between the new disruption and each of the maintained disruptions may be computed, with the disruption having the shortest statistical distance being selected as the earlier disruption. The corresponding set of tasks performed for recovery from the earlier disruption is provided as recommendation for recovery from the new disruption.

### PRIORITY CLAIM

The instant patent application is related to and claims priority from the co-pending provisional India patent application entitled, “Machine Learning Approach For Disruptions In Airline Operations And Recovery”, Serial No.: 5155/CHE/2013, Filed: 13 Nov. 2013, which is incorporated in its entirety herewith to the extent not inconsistent with the disclosure herein.

### BACKGROUND OF THE DISCLOSURE

1. Technical Field

The present disclosure relates to airline management systems and more specifically to providing guidance for recovery from disruptions in airline operations.

2. Related Art

Airlines are used for transporting people (passengers) and goods (cargo) between locations of various distances. Operation of airlines entails management/scheduling of various resources such as aircrafts, airports, crew and amenities/consumables (towels, food items, etc.).

Disruptions are often encountered to operation of airlines. A disruption necessarily implies the unavailability of one or more resources (for their intended use) forcing the rescheduling of such resources and potentially other resources as well. For example, the ash cloud created by the eruption of a volcano in Iceland in 2010 caused unavailability of various resources such as aircrafts and airports, thereby in turn causing disruptions to airline operations across various European countries, which in turn disrupted operation of airlines globally.

Recovery from such disruptions typically entails rescheduling resources and performing various other management tasks suited for the corresponding situation, such that the operation of the airlines is restored to normal steady state. Challenges are presented in recovery in view of factors such as disruptions occurring unexpectedly, operation personnel not having prior experience with the specific type of disruptions, etc.

There is a general need to provide suitable guidance to operations personnel for effective recovery, as suited in the corresponding environment. Aspects of the present disclosure provide guidance (to operational personnel) for recovery from disruptions in airline operations as described below with examples.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present invention can be implemented.

FIG. 2 is a flow chart illustrating the manner in which guidance for recovery from disruptions in airline operations is provided according to an aspect of the present disclosure.

FIG. 3A illustrates a partial list of disruption parameters maintained as part of a disruption data in one embodiment.

FIG. 3B illustrates a partial list of recovery tasks maintained as part of a disruption data in one embodiment.

FIG. 3C illustrates a partial list of reference parameters that may be maintained as part of a disruption data in one embodiment.

FIG. 3D illustrates a partial list of user impression parameters that may be maintained as part of a disruption data in one embodiment.

FIG. 4A illustrates the various vectors that are stored as part of a disruption data in one embodiment.

FIG. 4B illustrates the values stored as vectors as part of a disruption data in one embodiment.

FIG. 5 is an example implementation of disruption management server (150).

FIG. 6 is a block diagram illustrating the details of digital processing system 600 in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides guidance for recovery from disruptions in airline operations. In one embodiment, a disruption data specifying the details of disruptions in airline operations and a corresponding set of tasks performed for recovery for each disruption is maintained. In response to receiving an input data indicating details of a new disruption, an earlier disruption that is closest to the new disruption is identified based on the input data and the disruption data. For example, a statistical distance between the new disruption and each of the maintained disruptions may be computed, with the disruption having the shortest statistical distance being selected as the earlier disruption. The corresponding set of tasks performed for recovery from the earlier disruption is provided as recommendation for recovery from the new disruption.

In one embodiment, each disruption in the disruption data is represented as a vector of corresponding values for a set of pre-defined parameters. The input data is also in the form of an input vector containing corresponding values for the parameters. Accordingly, the statistical distance corresponds to a Euclidian distance between the input vector and each of the vectors corresponding to the maintained disruptions.

According to another aspect of the present disclosure, the set of tasks for recovery from an earlier disruption is first retrieved and then adjusted to scale to the magnitude of a new disruption. The adjusted set of tasks is then provided as the recommendation for recovery from the new disruption. In response to receiving an update data indicating the specific set of tasks performed for recovery from the new disruption, the disruption data is updated with the details of the new disruption and the update data.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

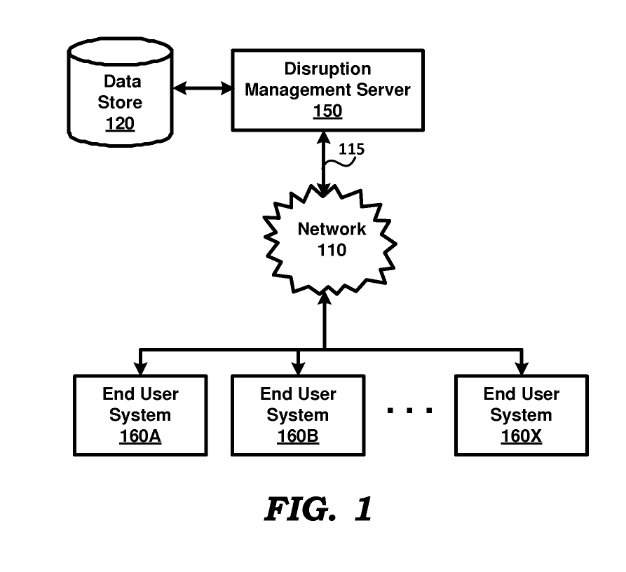

FIG. 1 is a block diagram illustrating an example environment (computing system) in which several aspects of the present invention can be implemented. In one embodiment, the computing system of FIG. 1 is provided for management of airline operations. The computing system is shown containing network 110, data store 120, disruption management server (DMS) 150 and end user systems 160A-160X.

Merely for illustration, only representative number/type of systems is shown in FIG. 1. Many environments often contain many more systems, both in number and type, depending on the purpose for which the environment is designed. Each block of FIG. 1 is described below in further detail.

Network 110 provides connectivity between DMS 150 and end user systems 160A-160X, and may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 110.

Data store 120 represents a non-volatile (persistent) storage facilitating storage and retrieval of a collection of data by DMS 150. Data store 120 may be implemented as a database server using relational database technologies and accordingly provide storage and retrieval of data using structured queries such as SQL (Structured Query Language). Alternatively, data store 120 may be implemented as a file server providing storage and retrieval of data in the form of files organized as one or more directories, as is well known in the relevant arts.

Each of end user systems 160A-160X represents a system such as a personal computer, workstation, mobile station, mobile phones, computing tablets, etc., used by users to generate requests directed to DMS 150. The requests may be generated using appropriate user interfaces (e.g., web pages provided by DMS 150, a native user interface provided by a portion of the application downloaded from DMS 150, etc.). In general, an end user system sends requests for performing desired tasks to DMS 150, and receives corresponding responses containing the results of performance of the requested tasks.

Disruption management system (DMS) 150 represents a server, such as a web/application server, capable of performing tasks requested by users using one of end user systems 160A-160X. DMS 150 may use data stored internally (for example, in a non-volatile storage/hard disk within the system), external data such as in data store 120 and/or data received from external sources (e.g., from the user) in performing such tasks. DMS 150 then sends the result of performance of the tasks to the requesting end user system (one of 160A-160X). The results may be accompanied by specific user interfaces (e.g., web pages) for displaying the results to the requesting user.

It may be appreciated that users (such as employees/operation personnel of an airline) send requests (using one of end user systems 160A-160X) to DMS 150 in response to a disruption occurring in the operations of an airline. Such disruptions may be caused by unavailability of crew due to strikes, illness or being stranded at another place, etc., unavailability of aircrafts due to breakdowns, overdue maintenance or inspection delays on the ground, etc., schedule and connection delays due to unexpected weather conditions at originating or destination airports, and other natural or man-made calamities. Recovery (by rescheduling and performance of other management tasks) from such disruptions is generally complex and spans a long duration (e.g., days or weeks).

DMS 150, provided according to several aspects of the present invention, provides guidance to the users for recovery from disruptions in airline operations as described below with examples.

### 3. Providing Guidance for Recovery from Disruptions

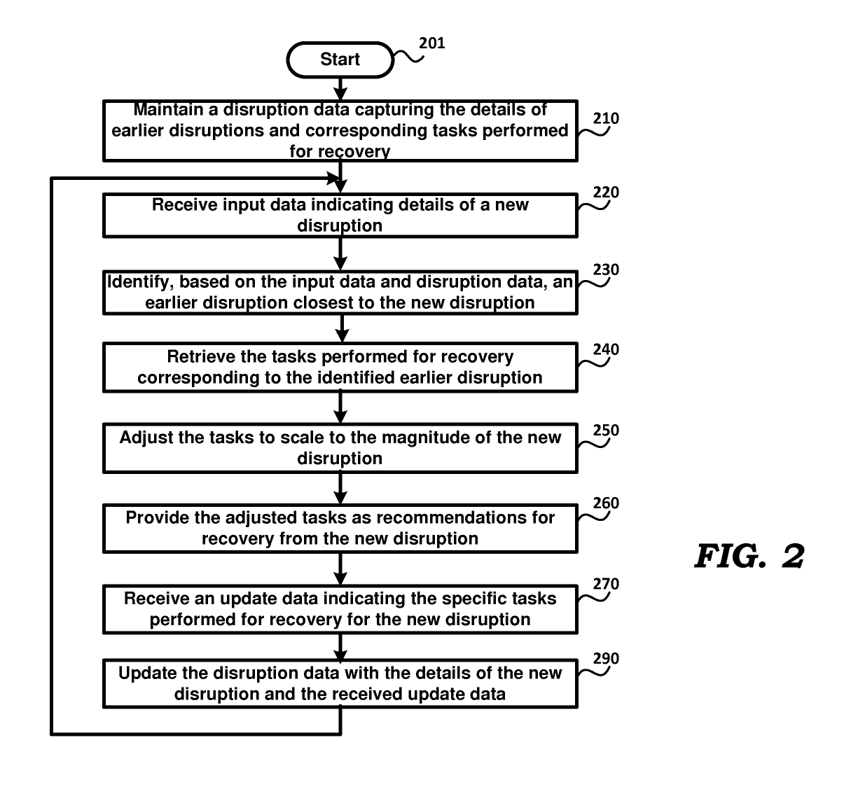

FIG. 2 is a flow chart illustrating the manner in which guidance for recovery from disruptions in airline operations is provided according to an aspect of the present disclosure. The flowchart is described with respect to disruption management server (DMS) 150 of FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, DMS 150 maintains a disruption data capturing the details of earlier disruptions in airline operations and corresponding tasks performed for recovery. The disruption data may be stored (in corresponding tables or as files) in data store 120. In one embodiment, the characteristics of each disruption is represented as corresponding (vector of) values for a pre-defined set of parameters (such as the number of aircrafts affected by the disruption, the number of crew affected, the delays in the schedule of the aircrafts, the number of aircrafts diverted, etc.)

In step 220, DMS 150 receives input data indicating details of a new disruption. The input data may be received from one of end user systems 160A-160X, in response to a user entering the data in a corresponding user interface. In one embodiment, the input data is also in the form of a corresponding vector of values for the pre-defined set of parameters.

In step 230, DMS 150 identifies based on the input data and disruption data, an earlier disruption closest to the new disruption. For example, DMS 150 may compute a statistical distance between the vectors of the new disruption and each of the earlier disruptions maintained in the disruption data, and then selects the disruption with the shortest distance as being the closest earlier disruption.

Any convenient statistical distance may be chosen, and the corresponding computations performed for identifying the closest disruption. For example, the statistical distance may be chosen to be the Euclidian distance between the vectors representing the new disruption and each of the earlier disruptions. Accordingly, the distance between the new disruption and an earlier disruption is computed as the square root of the sum of the squares of the differences in values, as is well known in the relevant arts.

In step 240, DMS 150 retrieves (from data store 120) the tasks performed for recovery corresponding to the identified earlier disruption. The recovery tasks may include one or more of recovery actions to be performed, the end state characteristics indicating the state of the system (airline operations) after recovery is completed, the end resultant values for some of the parameters, etc.

In step 250, DMS 150 adjusts the recovery tasks to scale to the magnitude of the new disruption. Such scaling may be necessitated in the scenario that the new disruption is similar to the identified earlier disruption, but is different only in the magnitude of the disruption (for example, 10 aircrafts being cancelled in the new disruption as compared to 5 aircrafts being cancelled in the earlier disruption, with other values of the parameters being relatively the same).

In step 260, DMS 150 provides the adjusted recovery tasks as recommendation/guidance for recovery from the new disruption. In one embodiment, the adjusted recovery tasks may be sent as a corresponding response to the input data to the requesting end user system (160A-160X), with the tasks then being displayed on a user interface in the end user system. A user/operations personnel may thereafter perform the recommendation for the recovery to cause the airline operation to be restored to a normal steady state.

In step 270, DMS 150 receives an update data indicating the specific tasks performed for recovery from the new disruption. In step 290, DMS 150 updates the disruption data (in data store 120) with the details of the new disruption and the received updated data. Control passes to step 220, to await further requests (from end user systems 160A-160X) indicating new disruptions. It should be appreciated that the operation of steps 270 and 290 ensures that the disruption data is kept up to date with the details of the latest disruptions in airline operations, and accordingly enables an airline to build a knowledge base of disruptions and corresponding recovery tasks over a period.

Thus, guidance (in the form of recommendation) for recovery from disruptions in airline operations is provided to various operations personnel of an airline. By providing such previously maintained recovery tasks, the turnaround time for recovery operations may be improved (in comparison to the state where no such guidance is available). The improved turnaround time in turn may cause cost reduction due to saving of time, reduced damage payouts and an improved image in the market for both airlines and airports.

The manner in which DMS 150 may maintains disruption data specifying the details of the various disruptions and corresponding recovery tasks performed for each of the disruptions is described below with examples.

### 4. Disruption Data

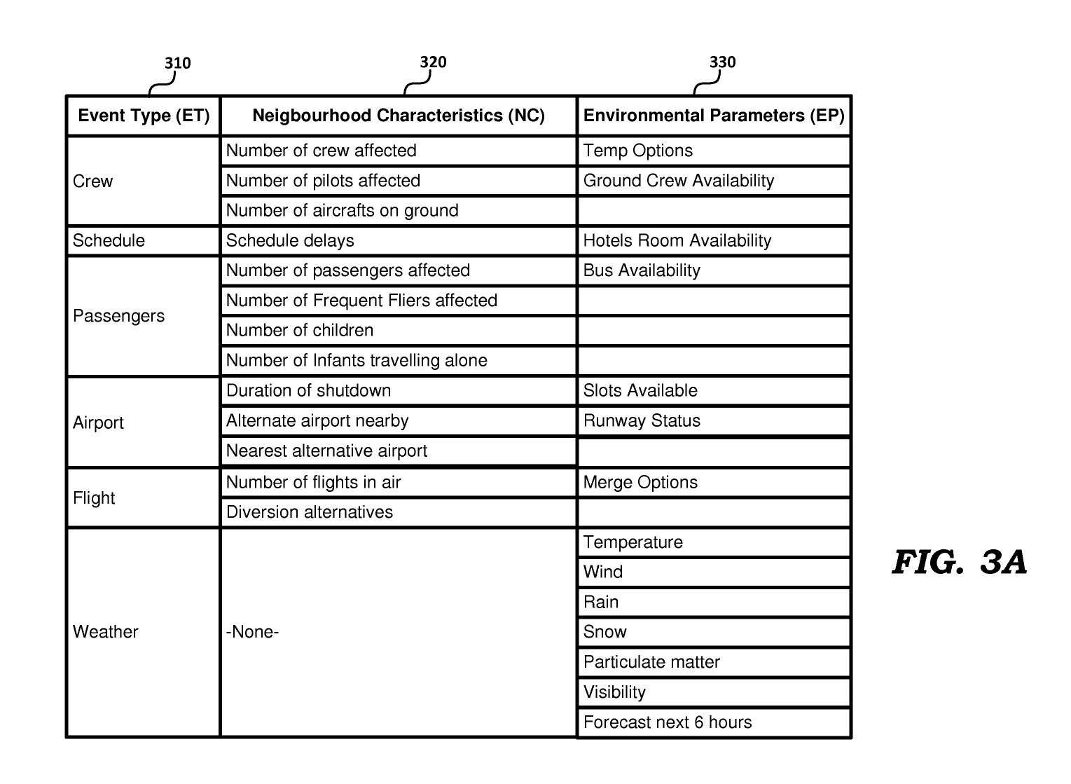

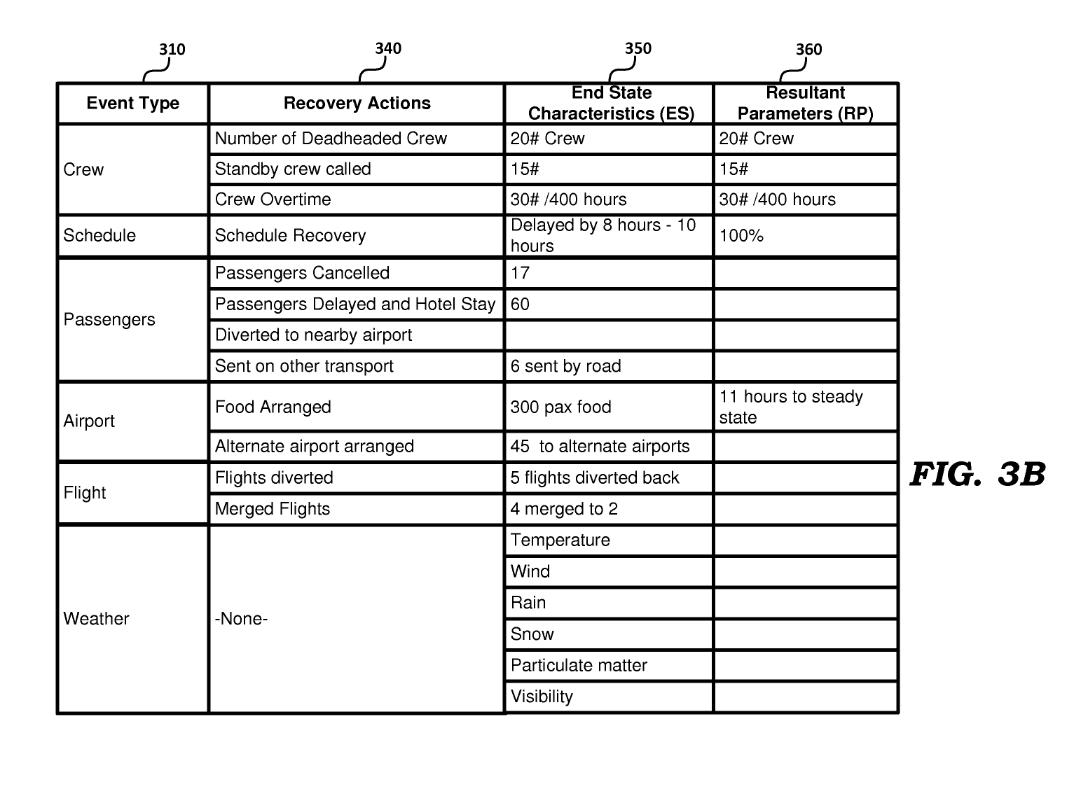

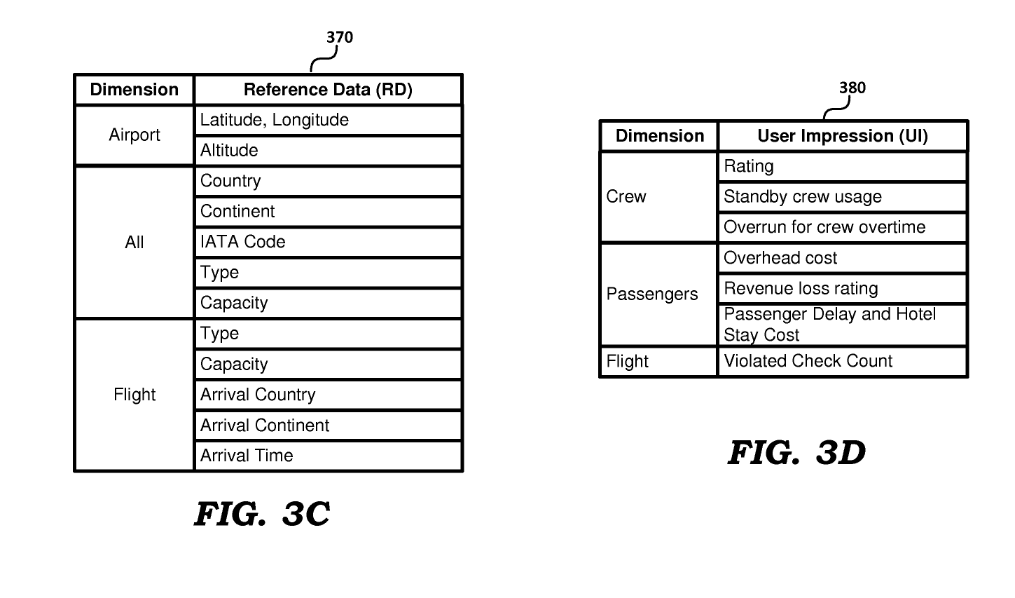

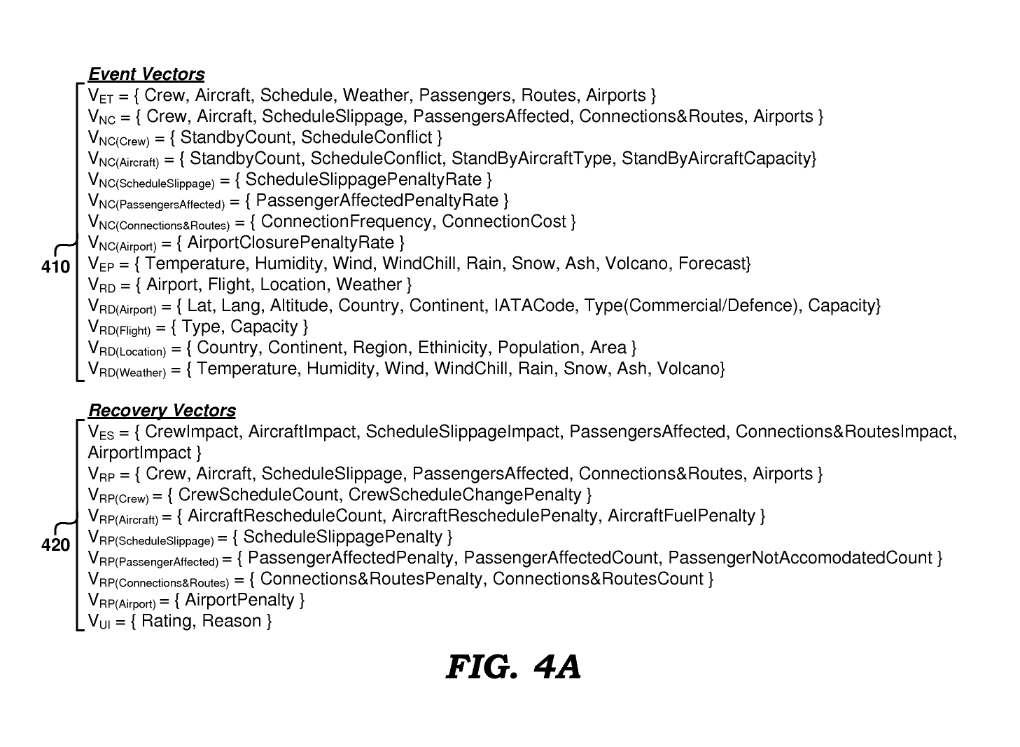

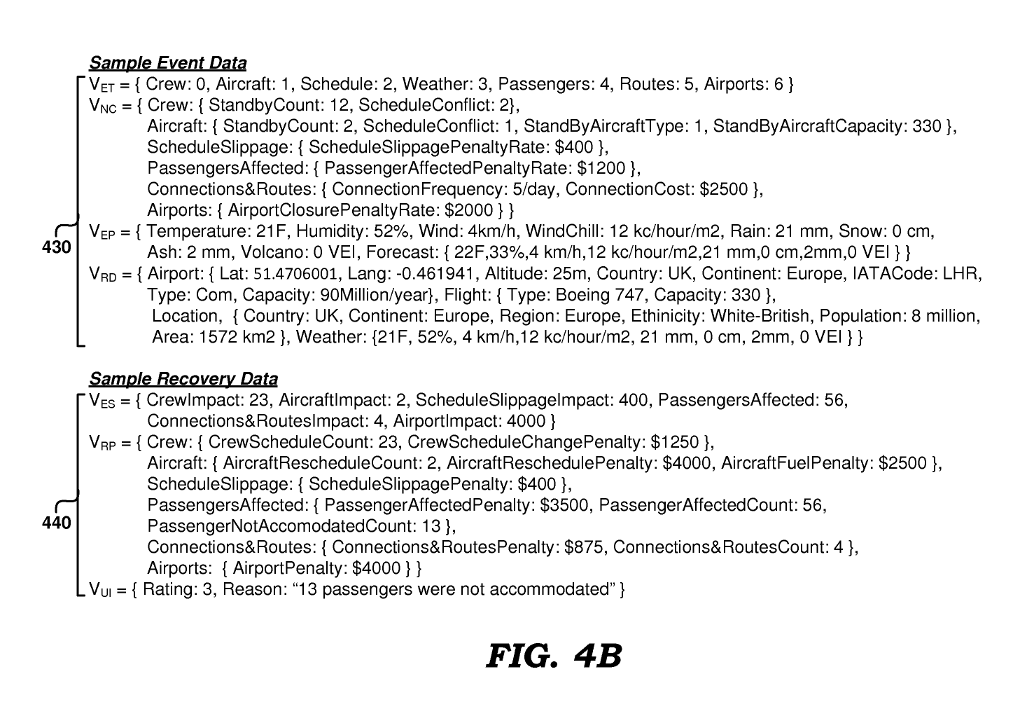

FIGS. 3A-3D and 4A-4B together illustrate the manner in which disruption data is maintained in one embodiment. In one embodiment, the state of disruption and corresponding recovery tasks is captured as a (vector) of corresponding values of a set of pre-defined parameters. Some of the parameters whose values may be captured (and stored) as part of disruption data is described in detail below.

It should be noted that only a sample list of parameters is shown herein for illustration, and in actual embodiments, the number/type of parameters may be large (100+) as suitable to the environment in which the features of the present disclosure are sought to be implemented. For convenience, the parameters are shown organized in the form of tables.

FIG. 3A illustrates a partial list of disruption parameters maintained as part of a disruption data in one embodiment. Column 310 specifies the various event types (ET) that may cause disruptions in airline operations. The event type is a resource that is unavailable and is one of the causes of a disruption, that is, multiple event types may be the causation of a single disruption in airline operation.

Column 320 specifies the neighborhood characteristics (NC) that are captured associated with each event type. For example, with respect to a crew event type (that is for unavailability of crew), the number of crew affected, the number of pilots affected and the number of aircrafts on ground are captured as the neighborhood characteristics. In general, the neighborhood characteristics capture the data about the neighborhood around the event type such as the resources available (or on standby), actual environmental parameters, data on nearby geography etc. Column 330 specifies the various environmental parameters (EP) that are captured associated with each event type. The environmental parameters generally capture the environment and the changing nature of the airline operations.

FIG. 3B illustrates a partial list of recovery tasks maintained as part of a disruption data in one embodiment. It may be observed that the recovery tasks are specified corresponding to the various event types indicated in column 310.

Column 340 specifies the various recovery actions that may be performed corresponding to each event type. For example, for flight event type (that is when flights/aircrafts are unavailable), column 340 indicates that the recovery actions of “Flights diverted” and “Merged flights” may be performed to restore the operation to normal steady state. Other recovery actions that may be specified include but are not limited to closure of airports, cancellation of flights, etc.

Column 350 specifies the various end state characteristics (ES) specifies the various characteristics/values that specify the end state reached when the recovery from a corresponding event type/disruption is completed (or is deemed to be completed). For example, for an airport event type/disruption, the end state after recovery is reached when the food has been arranged for 300 passengers (pax) and 45 passengers have been arranged to fly from alternate airports.

Column 360 specifies the resultant parameters (RP), that is the values for (some of) the parameters after the recovery is completed (or deemed to be completed). For example, schedule recovery is indicated to have the value “100%” upon completion of the recovery from a schedule event type disruption. In general, the resultant parameters specify the changes in the pre-defined/operating parameters of the system upon completion of recovery.

FIG. 3C illustrates a partial list of reference parameters that may be maintained as part of a disruption data in one embodiment. The reference parameters are shown specified corresponding to the various dimensions (event types). Column 370 specifies the reference data/parameters (RD) maintained as part of disruption data. The reference data/parameters indicate the relatively static data/characteristics pertaining to various dimensions/event types such as airports, flights, passenger, location, weather, etc. Examples of such reference parameters are the altitude of an airport, the length of the runways available in an airport, the type/capacity of a flight, etc.

FIG. 3D illustrates a partial list of user impression parameters that may be maintained as part of a disruption data in one embodiment. Column 380 specifies the various user impression (UI) parameters that are captured associated with each dimension/event type. The user impressions are made up of the user/operation personnel's tacit knowledge, impressions and notes relating to the recovery and the corresponding disruption. For example, for the crew, column 380 indicates that the user impression parameters of the recovery that are to be captured are crew rating (e.g. 6/10), the usage of standby crew (e.g. under limits), and the overrun (e.g. 3%) on the allowed crew overtime as indicated in column 350.

It may be observed that FIGS. 3A and 3C specifies various “disruption” parameters that capture the state of the disruption, while FIGS. 3B and 3D specifies various “recovery parameters” that captures the recovery tasks performed for the disruption. Disruption data stored in data store 120 contains various values specified for the both the disruption and recovery parameters noted in FIGS. 3A-3D as described below with examples.

FIG. 4A illustrates the various vectors that are stored as part of a disruption data in one embodiment. As noted above, the corresponding values of the parameters are stored in the form of various vectors, with each vector representing a corresponding set of values (for corresponding parameters). Thus, data portion 410 indicates various event/disruption vectors that may be stored as part of disruption data, while data portion 420 indicates various recovery vectors that may be stored as part of disruption data.

V_{ET} is a vector of values that indicates whether a corresponding event type is present in a disruption. Similarly, other vectors such as V_{NC}, V_{EP}, etc. in data portion 410 specify the values of the event/disruption parameters, while vectors such as Y_{ES}, V_{RP}, etc. in data portion 420 specify the values of recovery parameters. It may be observed that some of the vectors are shown to be formed from multiple (child) vectors. For example, the vector V_{NC} for neighborhood characteristics (NC) is shown to be formed from vectors such as V_{NC(Crew)}, V_{NC(Aircraft)}, V_{NC(Airport)} etc. As such, a disruption is enabled to be captured at a lower granularity level, thereby facilitating identification of earlier disruptions that are closest to new disruptions.

It should be appreciated that the vectors in data portions 410 and 420 capture the values of some of the parameters shown in FIGS. 3A-3D. However, in alternative embodiments, the number/size of the vectors may be chosen to capture more/less number of parameters, as will be apparent to one skilled in the relevant arts by reading the disclosure herein.

FIG. 4B illustrates the values stored as vectors as part of a disruption data in one embodiment. Data portion 430 specifies a sample set of values corresponding to some of the disruption vectors shown in data portion 410, while data portion 440 specifies sample a set of values corresponding to some of the recovery vectors shown in data portion 420.

For ease of understanding, each element in the vector is shown in the format “label: value”, where the label corresponds the name of the element noted in the vector in data portions 410/420, while the value represents the actual value stored as part of disruption data. In actual implementation, only the values may be stored as part of the disruption data. Thus, the V_{ET}={Crew: 0, Aircraft: 1, Schedule: 2, Weather: 3, Passengers: 4, Routes: 5, Airports: 6} may be represented in a shorted form as V_{ET}={0, 1, 2, 3, 4, 5, 6}.

It may be appreciated that data portions 430 and 440 together captures the details of a disruption, including the tasks performed for recovery from the disruption. It may also be observed that the vector V_{NC} for neighborhood characteristics (NC) is shown to be formed from multiple vectors of values corresponding to V_{NC(Crew)}, V_{NC(Aircraft)}, V_{NC(Airport)} etc.

It should be further appreciated that the values specified for the different parameters may be conveniently chosen to capture the disruption and corresponding recovery. For example, for parameters such as crew and passengers, the value may represent the actual number present in the disruption. For other parameters such as wind, snow, etc. as suitable scale of values (representing various degrees) may be chosen and the value may represent one of the degrees along the scale. For some other parameters, a Boolean value may be chosen with one of the values (e.g. 1) indicating the presence of the parameter in the disruption, and the another value (e.g. 0) indicating otherwise.

Thus, disruption data specifying the details of the various disruptions and corresponding recovery tasks performed for each of the disruptions is maintained by DMS 150. The manner in which new disruptions are processed based on such disruption data is described below with examples.

### 5. Processing New Disruptions

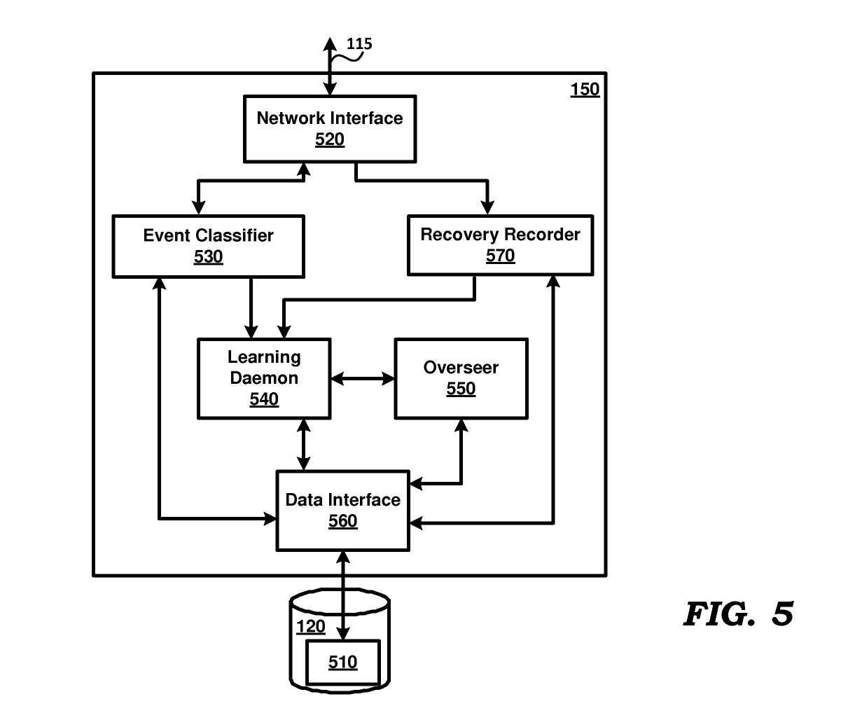

FIG. 5 is an example implementation of disruption management server (150). DMS 150 is shown containing network interface 520, event classifier 530, learning daemon 540, overseer 550, data interface 560 and recovery recorder 570, while data store 120 is shown containing disruption data 510. Each of the blocks is described in detail below.

Disruption data 510, shown stored in data store 120, may correspond to the values of the vectors shown in data portions 430/440 in FIG. 4B. Disruption data 510 may be stored (in corresponding tables or as files) in data store 120.

Network interface 520 receives (via path 115) requests from end user systems 160A-160X and forwards the requests to other blocks in DMS 150. In particular, network interface 520 receives requests containing input data (specifying the details of a new disruption) and forwards the requests to event classifier 530.

Event classifier 530 determines the specific event types affected by the new disruption based on disruption data 510. Event classifier 530 may first retrieve disruption data 510 (or specific portions thereof) from data store 120 using data interface 560. Data interface 560 facilitates other blocks of DMS 150 to store/retrieve data from disruption data 510, and may be implemented consistent with the implementation of data store 120, as will be apparent to one skilled in the relevant arts. In response to classifying a new disruption as being related to/caused by one or more event types, event classifier 530 forwards the input data and the determined event types to learning daemon 540.

Learning daemon 540 is a daemon process that continuously executes in the background and which determines the co-relation between a disruption and the corresponding recovery. In response to receiving the input data, learning daemon 540 determines the earlier disruption that is closest to the new disruption (based on disruption data 510 retrieved via data interface 560).

In one embodiment, the input data is also received in the form of input vector(s) of values (corresponding to the various parameters noted above), and accordingly learning daemon 540 computes a Euclidian distance between the input vector(s) and the vector(s) corresponding to the disruptions. Learning daemon 340 may compute the Euclidian distance using the below formula:

$$\sqrt{{\sum }_{all i} {( {X}_{i} - {Y}_{i} )}^{z}}$$

Where Xᵢ represents a corresponding value in the new vector and Yᵢ represents a corresponding value in the vector corresponding to the disruption (being compared to the new disruption). Learning daemon 540 then selects the disruption having the shortest/minimum Euclidian distance as the earlier disruption that is closest to the new disruption. Learning daemon 540 then forwards the identified earlier disruption to overseer 550.

Overseer 550, in response to receiving the earlier disruption, retrieves the tasks performed for recovery from the earlier disruption. Overseer 550 then determines whether there is a difference in magnitude between the new disruption and the earlier disruption. In the scenario that such a difference exists, overseer 550 adjusts the recovery tasks to scale to the magnitude of the new disruption. Overseer 550 then forwards the retrieved/adjusted recovery tasks as a recommendation to learning daemon 540, which in turn forwards the recommendation to network interface 520 (via event classifier 530).

Network interface 520 receives the recommendation for recovery from event classifier 530 and forwards (via path 115) the recommendation as corresponding responses to the requests (to the requesting end user system). Network interface 520 also receives requests containing update data (indicating the tasks performed for recovery from the new disruption) and forwards them to recovery recorder 570. The update data is received in the form of one or more of the recovery vectors shown in FIG. 4A. Recovery recorder 570 receives and stores (using data interface 560) the update data as part of disruption data 510.

Thus, DMS 150 provides guidance for recovery from new disruptions in airline operations. It should be noted that in response to receiving the responses from DMS 150, an end user system (such as 160A-160X) may display the recommendation to the users/operations personnel, thereby enabling the users to perform various tasks for recovery from the new disruption in the airline operations.

It should be further appreciated that the features described above can be implemented in various embodiments as a desired combination of one or more of hardware, executable modules, and firmware. The description is continued with respect to an embodiment in which various features are operative when executable modules are executed.

### 6. Digital Processing System

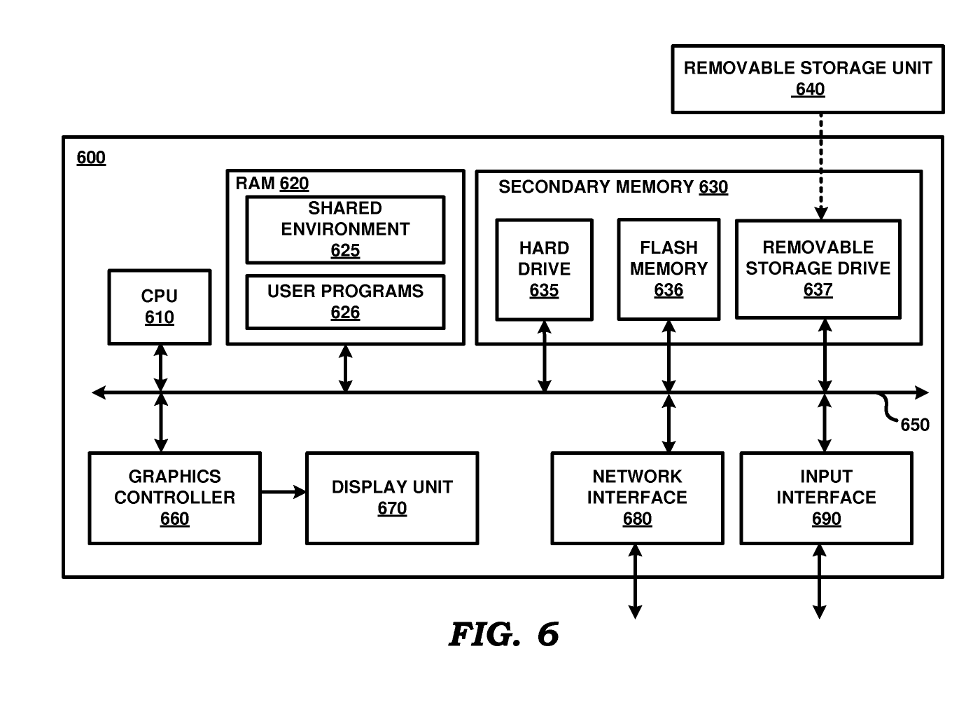

FIG. 6 is a block diagram illustrating the details of digital processing system 600 in which various aspects of the present disclosure are operative by execution of appropriate executable modules. Digital processing system 600 corresponds to disruption management server 150.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and user programs 626. Shared environment 625 includes operating systems, device drivers, virtual machines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide appropriate inputs. Network interface 680 provides connectivity to a network (e.g., using Internet Protocol), and may be used to communicate with other systems (of FIG. 1) connected to the network (110).

Secondary memory 630 may contain hard drive 635, flash memory 636, and removable storage drive 637. Secondary memory 630 may store the data (for example, portions of the data shown in FIGS. 4A-4B) and software instructions (for implementing the flowchart of FIG. 2), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as secondary memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A method of providing guidance for recovery from disruptions in airline operations, said method comprising:
maintaining a disruption data specifying the details of a plurality of disruptions in airline operations and a corresponding set of tasks performed for recovery for each disruption of said plurality of disruptions;
receiving an input data indicating details of a new disruption;
identifying, based on said input data and said disruption data, an earlier disruption of said plurality of disruptions that is closest to said new disruption; and
providing the corresponding set of tasks performed for recovery from said earlier disruption as recommendation for recovery from said new disruption.

2. The method of claim 1, said identifying comprising:
computing a statistical distance between said new disruption and each of said plurality of disruptions; and
selecting the disruption having the shortest statistical distance as said earlier disruption.

3. The method of claim 2, wherein each of said plurality of disruptions is represented as a corresponding one of a plurality of vectors, each vector comprising corresponding values for a plurality of parameters,
wherein said input data is in the form of an input vector comprising corresponding values for said plurality of parameters,
wherein said statistical distance corresponds to an Euclidian distance between said input vector and each of said plurality of vectors.

4. The method of claim 3, wherein said plurality of parameters includes an event type parameter indicating the type of a disruption, parameters capturing the neighborhood characteristics of said event type, environment parameters that captures the environment of the airline operations and reference parameters that indicates static characteristics of the airline operations.

5. The method of claim 3, wherein the corresponding set of tasks performed for recovery for a disruption includes one or more of the recovery actions to be performed, the end state characteristics indicating the state of the airline operations after recovery from the disruption is completed, the end resultant values for some of said plurality of parameters and user impressions on the disruption and corresponding recovery.

6. The method of claim 1, wherein said maintaining stores said disruption data in a data store, said method further comprising:
retrieving, from said data store, the corresponding set of tasks performed for recovery from said earlier disruption; and
adjusting the set of tasks to scale to the magnitude of said new disruption,
wherein said providing provides the adjusted set of tasks as said recommendation for recovery from said new disruption.

7. The method of claim 6, further comprising:
receiving an update data indicating the specific set of tasks performed for recovery from said new disruption; and
updating said disruption data with the details of said new disruption and said update data.

8. A non-transitory machine readable medium storing one or more sequences of instructions for causing a system to provide guidance for recovery from disruptions in airline operations, wherein execution of said one or more instructions by one or more processors contained in said system causes said system to perform the actions of:
maintaining a disruption data specifying the details of a plurality of disruptions in airline operations and a corresponding set of tasks performed for recovery for each disruption of said plurality of disruptions;
receiving an input data indicating details of a new disruption;
identifying, based on said input data and said disruption data, an earlier disruption of said plurality of disruptions that is closest to said new disruption; and
providing the corresponding set of tasks performed for recovery from said earlier disruption as recommendation for recovery from said new disruption.

9. The machine readable medium of claim 8, said identifying comprising one or more instructions for:
computing a statistical distance between said new disruption and each of said plurality of disruptions; and
selecting the disruption having the shortest statistical distance as said earlier disruption.

10. The machine readable medium of claim 9, wherein each of said plurality of disruptions is represented as a corresponding one of a plurality of vectors, each vector comprising corresponding values for a plurality of parameters,
wherein said input data is in the form of an input vector comprising corresponding values for said plurality of parameters,
wherein said statistical distance corresponds to an Euclidian distance between said input vector and each of said plurality of vectors.

11. The machine readable medium of claim 10, wherein said plurality of parameters includes an event type parameter indicating the type of a disruption, parameters capturing the neighborhood characteristics of said event type, environment parameters that captures the environment of the airline operations and reference parameters that indicates static characteristics of the airline operations.

12. The machine readable medium of claim 10, wherein the corresponding set of tasks performed for recovery for a disruption includes one or more of the recovery actions to be performed, the end state characteristics indicating the state of the airline operations after recovery from the disruption is completed, the end resultant values for some of said plurality of parameters and user impressions on the disruption and corresponding recovery.

13. The machine readable medium of claim 8, wherein said maintaining stores said disruption data in a data store, further comprising one or more instructions for:
retrieving, from said data store, the corresponding set of tasks performed for recovery from said earlier disruption; and
adjusting the set of tasks to scale to the magnitude of said new disruption,
wherein said providing provides the adjusted set of tasks as said recommendation for recovery from said new disruption.

14. The machine readable medium of claim 6, further comprising one or more instructions for:
receiving an update data indicating the specific set of tasks performed for recovery from said new disruption; and
updating said disruption data with the details of said new disruption and said update data.

15. A digital processing system comprising:
a processor;
a random access memory (RAM);
a machine readable medium to store one or more instructions, which when retrieved into said RAM and executed by said processor causes said digital processing system to provide guidance for recovery from disruptions in airline operations, said digital processing system performing the actions of:
maintaining a disruption data specifying the details of a plurality of disruptions in airline operations and a corresponding set of tasks performed for recovery for each disruption of said plurality of disruptions;
receiving an input data indicating details of a new disruption;
identifying, based on said input data and said disruption data, an earlier disruption of said plurality of disruptions that is closest to said new disruption; and
providing the corresponding set of tasks performed for recovery from said earlier disruption as recommendation for recovery from said new disruption.

16. The digital processing system of claim 15, for said identifying, said digital processing system performing the actions of:
computing a statistical distance between said new disruption and each of said plurality of disruptions; and
selecting the disruption having the shortest statistical distance as said earlier disruption.

17. The digital processing system of claim 16, wherein each of said plurality of disruptions is represented as a corresponding one of a plurality of vectors, each vector comprising corresponding values for a plurality of parameters,
wherein said input data is in the form of an input vector comprising corresponding values for said plurality of parameters,
wherein said statistical distance corresponds to an Euclidian distance between said input vector and each of said plurality of vectors.

18. The digital processing system of claim 17, wherein said plurality of parameters includes an event type parameter indicating the type of a disruption, parameters capturing the neighborhood characteristics of said event type, environment parameters that captures the environment of the airline operations and reference parameters that indicates static characteristics of the airline operations.

19. The digital processing system of claim 17, wherein the corresponding set of tasks performed for recovery for a disruption includes one or more of the recovery actions to be performed, the end state characteristics indicating the state of the airline operations after recovery from the disruption is completed, the end resultant values for some of said plurality of parameters and user impressions on the disruption and corresponding recovery.

20. The digital processing system of claim 15, wherein said maintaining stores said disruption data in a data store, said digital processing system further performing the actions of:
retrieving, from said data store, the corresponding set of tasks performed for recovery from said earlier disruption;
adjusting the set of tasks to scale to the magnitude of said new disruption, wherein said digital processing system provides the adjusted set of tasks as said recommendation for recovery from said new disruption;
receiving an update data indicating the specific set of tasks performed for recovery from said new disruption; and
updating said disruption data with the details of said new disruption and said update data.
